(19) United States
(12) Patent Application Publication
(10) Pub. No.: US 2011/0170522 A1
(43) Pub. Date: Jul. 14, 2011

(54) WIRELESS TRANSMISSION METHOD FOR SPATIAL DIVISION MULTIPLE ACCESS SYSTEM

(75) Inventors: YEN CHIN LIAO, HSINCHU COUNTY (TW); CHENG HSUAN WU, HSINCHU COUNTY (TW); YUNG SZU TU, HSINCHU COUNTY (TW)

(73) Assignee: RALINK TECHNOLOGY CORPORATION, HSINCHU COUNTY (TW)

(21) Appl. No.: 12/987,692

(22) Filed: Jan. 10, 2011

(30) Foreign Application Priority Data
Jan. 11, 2010 (TW) 099100496

(51) Int. Cl. H04W 72/04; H04J 3/00; H04L 12/413

(52) U.S. Cl. 370/336; 370/445

(57) ABSTRACT

A wireless transmission method comprises the steps of: determining transmission time slots and start antenna indexes of a plurality of stations in a spatial division multiple access system according to the number of antennas of the plurality of stations; broadcasting a control frame signal to the plurality of stations and waiting for requests to transmit signals from the plurality of stations, wherein the control frame signal includes the transmission time slots and start antenna indexes of the plurality of stations; receiving the requests to transmit signals from the plurality of stations; and broadcasting a clear to transmit signal to the plurality of stations based on the received request to transmit signals. The requests to transmit signals of the plurality of stations, which are transmitted based on the transmission time slots and start antenna indexes of the plurality of stations, conform to a multi-input multi-output transmission standard of the access point.

### BACKGROUND OF THE INVENTION

1. Field of the Invention

The present invention relates to a wireless transmission method, and more particularly, to a wireless transmission method for a spatial division multiple access (SDMA) system.

2. Description of the Related Art

In designing a wireless communication system, to improve the transmission efficiency, designers often use some kind of multiple access system to transmit multiple data streams simultaneously. For example, time division multiple access (TDMA) technique divides a period of time into a plurality of time intervals and allocates such intervals for the data transmission from different data sources. Frequency division multiple access (FDMA) technique divides a fixed bandwidth into a plurality of frequency intervals and allocates such intervals for data transmitted from different data sources. Code division multiple access (CDMA) technique simultaneously transmits data transmission from different data sources using different types of encoding methods. These multiple access systems can receive different data streams simultaneously on the receiving end and individually extract each datum from the mixed receiving data. An SDMA system transmits data from different transmitting ends in space simultaneously. The receiving end in an SDMA system can extract the datum of each transmitting end from the mixed receiving data based on spatial diversity.

Currently, wireless local area network (WLAN) technology still transmits data in a point to point manner. However, with the development of WLAN technology and the increase of users, the current transmission method cannot meet the requirements of the industry. Therefore, it may become a standard requirement for the next generation's WLAN technology to process transmission requirements from different users in the same WLAN by an SDMA system. Needless to say, such standard must be backward compatible with the transmission method of the current WLAN technology.

Accordingly, there is a need to design a wireless transmission method for a spatial division multiple access system such that an access point and a plurality of stations in a WLAN can perform data transmission in an SDMA manner. In addition, such wireless transmission method must be backward compatible with the transmission method of the current WLAN technology.

### SUMMARY OF THE INVENTION

The wireless transmission method for a spatial division multiple access system according to one embodiment of the present invention comprises the steps of: determining transmission time slots and start antenna indexes of a plurality of stations in a spatial division multiple access system according to the number of antennas of the plurality of stations; broadcasting a control frame signal to the plurality of stations and waiting for requests to transmit signals from the plurality of stations, wherein the control frame signal includes the transmission time slots and start antenna indexes of the plurality of stations; receiving the requests to transmit signals from the plurality of stations; and broadcasting a clear to transmit signal to the plurality of stations based on the received request to transmit signals. The requests to transmit signals of the plurality of stations, which are transmitted based on the transmission time slots and start antenna indexes of the plurality of stations, conform to a multi-input multi-output transmission standard of the access point.

The wireless transmission method for a spatial division multiple access system according to another embodiment of the present invention comprises the steps of: receiving a broadcasted control frame signal, wherein the control frame signal includes transmission time slots and start antenna indexes of a plurality of stations in a spatial division multiple access system; transmitting a request to transmit signals to an access point with multiple antennas according to the transmission time slots and start antenna indexes of the plurality of stations and waiting for a clear to transmit signal from the access point with multiple antennas; receiving the clear to transmit signal from the access point with multiple antennas; and transmitting data signals to the access point with multiple antennas according to the clear to transmit signal. The request to transmit signal, which is transmitted based on the transmission time slots and start antenna indexes of the plurality of stations, conforms to a multi-input multi-output transmission standard of the access point.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows a schematic view of a WLAN;

FIG. 2 shows the flowchart of a wireless transmission method for an access point with multiple antennas of a spatial division multiple access system according to an embodiment of the current invention;

FIG. 3 shows the flowchart of a wireless transmission method for a station of a spatial division multiple access system according to an embodiment of the current invention;

FIG. 4 shows the timing diagram of the wireless transmission operation between an access point and a plurality of stations according to an embodiment of the current invention; and

FIG. 5 shows the flowchart of a setup method for transmission time slots and start antenna indexes of a spatial division multiple access system according to an embodiment of the current invention.

### DETAILED DESCRIPTION OF THE INVENTION

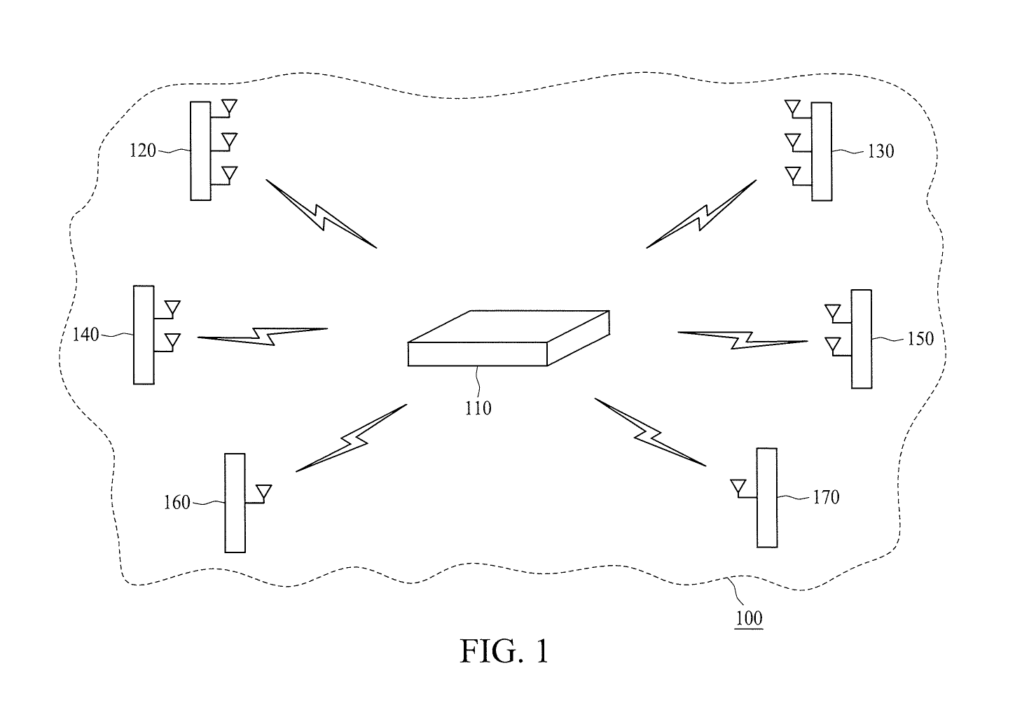

FIG. 1 shows a schematic view of a WLAN. As shown in FIG. 1, the WLAN 100 comprises an access point 110 and a plurality of stations 120 to 170. The access point 110 has four antennas. Each of the stations 120 and 130 has three antennas. Each of the stations 140 and 150 has two antennas. Each of the stations 160 and 170 has only one antenna. For the transmission method of the current WLAN technology, the access point 110 can only perform data transmission with a single station at a time, wherein such transmission method conforms to the multi-input multi-output (MIMO) specification. For example, the access point 110 can perform data transmission with the station 120 in a 4×3 MIMO manner, or the access point 110 can perform data transmission with the station 140 in a 4×2 MIMO manner. That is, under the transmission method of the current WLAN technology, if the access point 110 demands to perform data transmission with each of the stations 120 to 170, such data transmissions must be performed at different times. However, the wireless transmission method for a spatial division multiple access system provided by the current invention enables the data transmission between the access point 110 and the stations 120 to 170 in an SDMA manner.

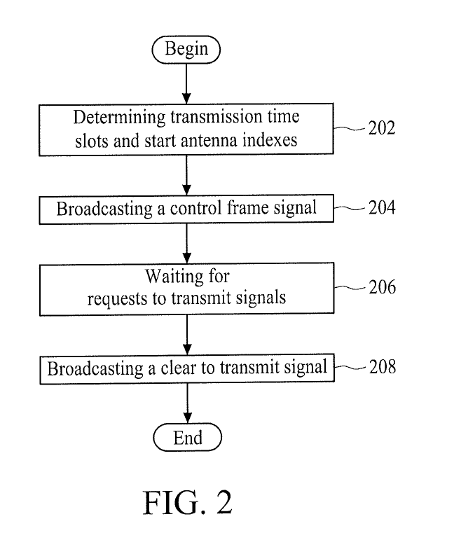

FIG. 2 shows the flowchart of the wireless transmission method for an access point with multiple antennas of a spatial division multiple access system according to an embodiment of the current invention. In step 202, transmission time slots and start antenna indexes of a plurality of stations in a spatial division multiple access system are determined according to the number of antennas of the stations, and step 204 is executed. In step 204, a control frame signal is broadcasted to the plurality of stations, and step 206 is executed, wherein the control frame signal includes the transmission time slots and start antenna indexes of the stations. In step 206, the process is paused to wait for requests to transmit signals from the stations, and step 208 is executed. In step 208, a clear to transmit signal is broadcasted to the stations based on the received requests to transmit signals after receiving the requests to transmit signals from the plurality of stations. It should noted that the requests to transmit signals of the stations, which are transmitted based on the transmission time slots and start antenna indexes of the stations, conform to a MIMO transmission standard of the access point.

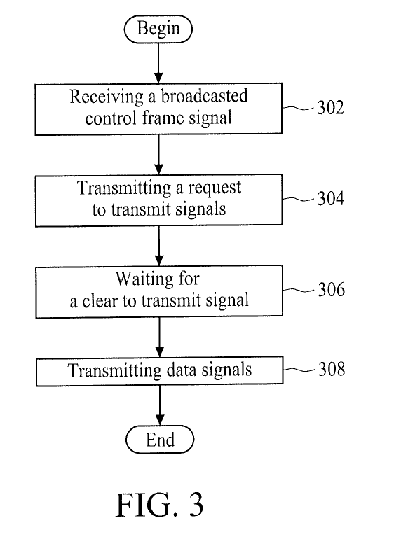

FIG. 3 shows the flowchart of the wireless transmission method for a station of a spatial division multiple access system according to an embodiment of the current invention. In step 302, a broadcasted control frame signal is received, and step 304 is executed, wherein the control frame signal includes transmission time slots and start antenna indexes of a plurality of stations in a spatial division multiple access system. In step 304, a request to transmit signals is transmitted to an access point with multiple antennas according to the transmission time slots and start antenna indexes of the plurality of stations, and step 306 is executed. In step 306, the process is halted to wait for a clear to transmit signal from the access point with multiple antennas, and step 308 is executed. In step 308, data signals are transmitted to the access point with multiple antennas according to the clear to transmit signal after the clear to transmit signal is received from the access point with multiple antennas. Similar to the wireless transmission method shown in FIG. 2, the request to transmit signals of the station, which is transmitted based on the transmission time slots and start antenna indexes of the stations, conforms to a MIMO transmission standard of the access point.

The following illustrates applying the wireless transmission method shown in FIGS. 2 and 3 to the WLAN 100 shown in FIG. 1. Initially, the access point 110 has the information of the WLAN 100. Therefore, the access point 110 is aware that the plurality of stations 120 to 170 are linked to the WLAN 100 and has the knowledge of the number of antennas of each of the stations 120 to 170. Accordingly, the wireless transmission method shown in FIG. 2 can be applied to the access point 110, and the wireless transmission method shown in FIG. 3 can be applied to the stations 120 to 170. In step 202, the access point 110 determines transmission time slots and start antenna indexes of the stations 120 to 170 according to the number of antennas of the stations 120 to 170. For example, the transmission time slots of the stations 120 and 170 can be set as the first transmission time slot, and the start antenna indexes of the stations 120 and 170 are then labeled as one and four respectively; the transmission time slots of the stations 130 and 160 can be set as the second transmission time slot, and the start antenna indexes of the stations 130 and 160 are then labeled as one and four respectively; and the transmission time slots of the stations 140 and 150 can be set as the third transmission time slot, and the start antenna indexes of the stations 140 and 15 are then labeled as one and three respectively.

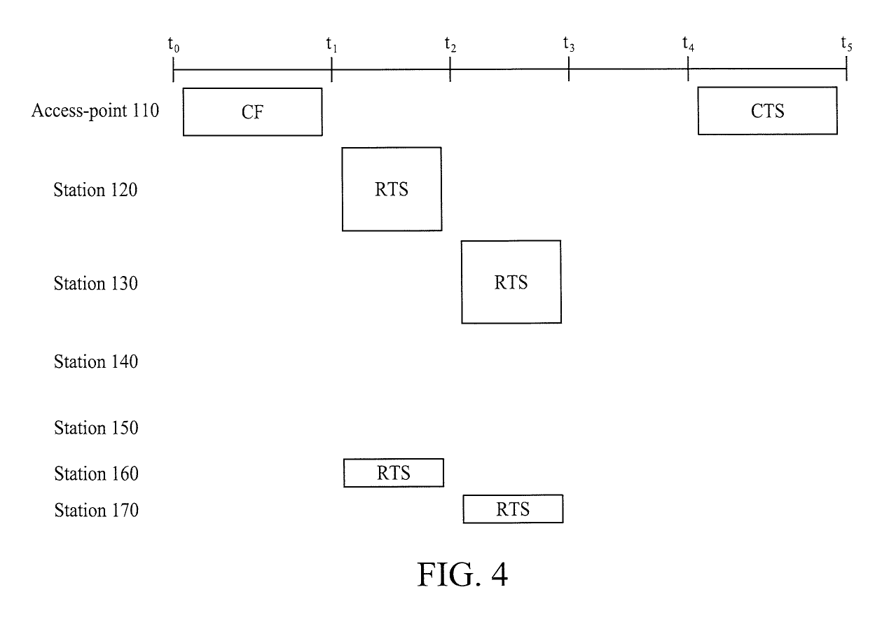

In step 204, the access point 110 broadcasts a control frame signal to the stations 120 to 170. In some embodiments of the present invention, the access point 110 first gains the qualification to transmit data in the WLAN 100 by applying carrier sense multiple access (CSMA) mechanism, and then broadcasts the control frame signal. FIG. 4 shows the timing diagram of the wireless transmission operation between the access point 110 and the stations 120 to 170. As shown in FIG. 4, the access point 110 transmits a control frame signal CF to the stations 120 to 170 in the time slot between t0 and t1.

In step 206, the access point 110 waits for requests to transmit signals from the stations 120 to 170. Meanwhile, in step 302, the stations 120 to 170 receive the broadcasted control frame signal. In step 304, each of the stations 120 to 170 who need to transmit data transmits a request to transmit signals to the access point 110 according to the transmission time slots and antenna indexes of the stations 120 to 170, wherein the requests to transmit signals of the stations, which are transmitted based on the transmission time slots and antenna indexes of the stations 120 to 170, conform to a MIMO transmission standard of the access point 110. As shown in FIG. 4, since the transmission time slots of the stations 120 and 170 are the first transmission time slot, both of the stations 120 and 170 can transmit a request to transmit signals RTS to the access point 110 in the time slot between t1 and t2. In addition, since the stations 120 and 170 are labeled as one and four, the station 120 transmits data with three antennas labeled with one, two and three, and the station 170 transmits data with a single antenna labeled with four. For the access point 110, the stations 120 and 170 can be treated as a virtual single station such that the access point 110 performs data transmission with the virtual station in a 4×4 MIMO manner.

Similarly, both of the stations 130 and 160 can transmit a request to transmit signals RTS to the access point 110 in the time slot between t2 and t3; the station 130 transmits data with three antennas labeled with one, two and three; and the station 160 transmits data with a single antenna labeled with four. In addition, since neither of the stations 140 and 150 needs to transmit data, neither of them transmits a request to transmit signals to the access point 110 in the time slot between t3 and t4. In step 306, the stations 120, 130, 160 and 170 wait for the clear to transmit signal from the access point 110.

In step 208, after the access point 110 receives the requests to transmit signals from the stations 120, 130, 160 and 170, it broadcasts a clear to transmit signal to the stations 120, 130, 160 and 170 based on the received requests to transmit signals. In some embodiments of the present invention, the received requests to transmit signals comprise updated transmission time slots and start antenna indexes corresponding to the stations 120, 130, 160 and 170. As shown in FIG. 4, the access point 110 then broadcasts a clear to transmit signal to the stations 120, 130, 160 and 170 in the time slot between t4 and t5. In step 308, after the stations 120, 130, 160 and 170 receive the clear to transmit signal, they can transmit data signals to the access point 110 according to the clear to transmit signal.

Since the requests to transmit signals and the transmitted data of the stations 120, 130, 160 and 170 are based on the transmission time slots and start antenna indexes configured by the stations 120, 130, 160 and 170, and conform to the MIMO transmission standard of the access point 110, the access point 110 is considered as transmit data with a single virtual station. Accordingly, the wireless transmission methods shown in FIGS. 2 and 3 are backward compatible with the transmission method of the conventional WLAN technology.

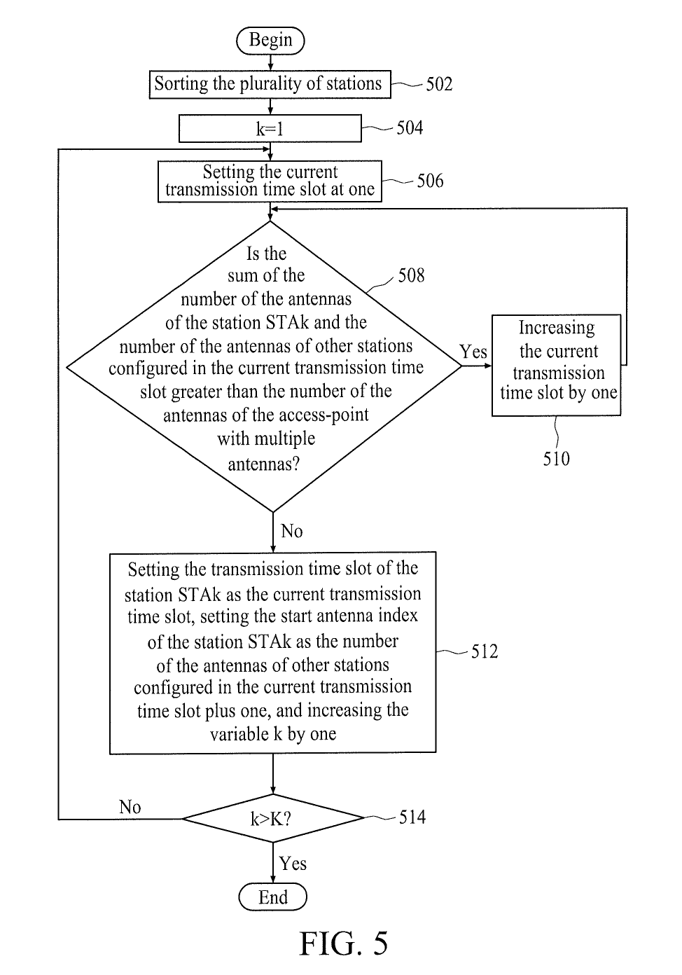

Referring back to FIG. 2, preferably, in step 202, the access point 110 can determine transmission time slots and start antenna indexes of the stations 120 to 170 according to the setup method shown in FIG. 5. In step 502, the plurality of stations are sorted in an order listing from STA1 to STAK, and step 504 is executed, wherein K is the number of stations. In step 504, a variable k is set at one, and step 506 is executed. In step 506, the current transmission time slot is set at one, and step 508 is executed. In step 508, a check is performed to determine whether the sum of the number of antennas of the station STAk and the number of antennas of other stations already being configured in the current transmission time slot is greater than the number of antennas of the access point with multiple antennas. If the check result is positive, step 510 is executed; otherwise, step 512 is executed. In step 510, the current transmission time slot is increased by one, and step 508 is executed. In step 512, the transmission time slot of the station STAk is set as the current transmission time slot, the start antenna index of the station STAk is set as the number of antennas of other stations already being configured in the current transmission time slot plus one, the variable k is increased by one, and step 514 is executed. In step 514, a check is performed to determine whether the variable k is greater than K. If the check result is positive, the present method is finished; otherwise, step 506 is executed.

Preferably, in step 502, the sorting of the stations is performed according to the number of antennas of each station. For example, the station in the first place of the sorted order could be the station with the greatest number of antennas, and the station in the last place of the sorted order could be the station with the smallest number of antennas. In some embodiments of the present invention, the clear to transmit signal in step 308 comprises updated transmission time slots and start antenna indexes corresponding to the stations. Preferably, the update of the transmission time slots and start antenna indexes could also follow the setup method shown in FIG. 5. In addition, in step 502, the stations to be sorted only include those stations from which the access point has received the requests to transmit signals. Similarly, the sorting of the stations could also follow the number of antennas of each station. For example, the station in the first place of the sorted order could be the station with the greatest number of antennas, and the station in the last place of the sorted order could be the station with the smallest number of antennas.

The following illustrates applying the setup method shown in FIG. 5 to the WLAN 100 shown in FIG. 1. In step 502, the stations 120 to 170 are sorted in an order listing from STA1 to STAG. In step 504, the variable k is set at one. In step 506, the current transmission time slot is set at one. In step 508, the station STA1 is checked. That is, a check is performed to determine whether the sum of the number of antennas of the station 120 and the number of antennas of other stations already being configured in the current transmission time slot is greater than the number of antennas of the access point 110. Since in the current transmission time slot, i.e. time slot one, there does not exist any configured station, the check result is negative, and step 512 is executed. In step 512, the transmission time slot of the station STA1, i.e. station 120, is set at one, the current transmission time slot; the start antenna index of the station STA1 is set at the number of antennas of other stations already being configured in the current transmission time slot plus one, i.e. one; and the variable k is increased by one to be two. In step 514, a check is performed to determine whether the variable k is greater than K. Since the variable k is two and is not greater than K, which is six, step 506 is executed. Accordingly, the transmission time slot of the station 120 is set as the first transmission time slot, and the start antenna index of the station 120 is set at one.

In step 506, the current transmission time slot is set at one. In step 508, the station STA2 is checked. That is, a check is performed to determine whether the sum of the number of antennas of the station 130 and the number of antennas of other stations already configured in the current transmission time slot, transmission time slot one, is greater than the number of antennas of the access point 110. Since in the current transmission time slot, i.e. time slot one, there already exists station 120, and the sum of the number of antennas of the stations 120 and 130 is six, which is greater than the number of antennas of the access point 110, four, step 510 is executed. In step 510, the current transmission time slot is increased by one to be two, and step 508 is executed. In step 508, the station STA2 is checked again. That is, a check is performed to determine whether the sum of the number of antennas of the station 130 and the number of antennas of other stations already configured in the current transmission time slot, transmission time slot two, is greater than the number of antennas of the access point 110. Since the check result is negative, in step 512, the transmission time slot of the station STA2, i.e. station 130, is set at two, the current transmission time slot; the start antenna index of the station 130 is set as the number of antennas of other stations already being configured in the current transmission time slot plus one, i.e. one; and the variable k is increased by one to be three. Accordingly, the transmission time slot of the station 130 is set as the second transmission time slot, and the start antenna index of the station 130 is set as one.

By continuing the setup method shown in FIG. 5, the transmission time slot of the station 140 is set as the third transmission time slot, and the start antenna index of the station 140 is set at one; the transmission time slot of the station 150 is set as the third transmission time slot, and the start antenna index of the station 150 is set at three; the transmission time slot of the station 160 is set as the first transmission time slot, and the start antenna index of the station 160 is set at four; and the transmission time slot of the station 170 is set as the second transmission time slot, and the start antenna index of the station 170 is set at four. Accordingly, the wireless transmission methods in the embodiments of the present invention can proceed according to the configured transmission time slot and start antenna indexes.

In conclusion, the wireless transmission methods for a spatial division multiple access system provided by the present invention enable data transmission between an access point and a plurality of stations in a WLAN in an SDMA manner. Accordingly, simultaneous transmission of data by several users is supported. In addition, since at any time, the access point in the SDMA system is deemed as performing data transmission with a single virtual station in a MIMO manner, the wireless transmission methods provided by the present invention are backward compatible with the transmission method of the conventional WLAN technology.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A wireless transmission method for a spatial division multiple access system, comprising the steps of:
determining transmission time slots and start antenna indexes of a plurality of stations in a spatial division multiple access system according to the number of antennas of the plurality of stations;
broadcasting a control frame signal to the plurality of stations and waiting for requests to transmit signals from the plurality of stations, wherein the control frame signal includes the transmission time slots and to start antenna indexes of the plurality of stations;
receiving the requests to transmit signals from the plurality of stations; and
broadcasting a clear to transmit signal to the plurality of stations based on the received request to transmit signals;
wherein the requests to transmit signals of the plurality of stations, which are transmitted based on the transmission time slots and start antenna indexes of the plurality of stations, conform to a multi-input multi-output transmission standard of the access point.

2. The wireless transmission method of claim 1, wherein the step of determining transmission time slots and start antenna indexes of the plurality of stations in a spatial division multiple access system comprises the sub-steps of:
determining transmission time slots of the plurality of stations according to a sorted order of the plurality of stations;
setting the current transmission time slot as the next time slot of the current transmission time slot if the sum of the number of antennas of a station to be set and the number of antennas of other stations in the current transmission time slot is greater than the number of antennas of the access point with multiple antennas;
setting the transmission time slot of a station to be set as the current transmission time slot if the sum of the number of antennas of the station to be set and the number of antennas of other stations in the current transmission time slot is not greater than the number of antennas of the access point with multiple antennas; and
setting the start antenna index of a station to be set according to the relation between the station to be set and other stations in the transmission time slot of the station to be set.

3. The wireless transmission method of claim 2, wherein the sorted order of the plurality of stations is determined by the number of antennas of each of the plurality of stations.

4. The wireless transmission method of claim 3, wherein the station with the greatest number of antennas is listed in the first place of the sorted order, and the station with the smallest number of antennas is listed in the last place of the sorted order.

5. The wireless transmission method of claim 1, wherein the step of broadcasting the control frame signal is performed by applying carrier sense multiple access mechanism.

6. The wireless transmission method of claim 1, wherein the clear to transmit signal comprises updated transmission time slots and start antenna indexes of the plurality of stations.

7. The wireless transmission method of claim 6, wherein the step of broadcasting a clear to transmit signal comprises the sub-steps of:
determining updated transmission time slots of the plurality of stations according to an updated sorted order of the plurality of stations;
setting the current transmission time slot as the next time slot of the current transmission time slot if the sum of the number of antennas of a station to be set and the number of antennas of other stations in the current transmission time slot is greater than the number of antennas of the access point with multiple antennas;
setting the transmission time slot of a station to be set as the current transmission time slot if the sum of the number of antennas of the station to be set and the number of antennas of other stations in the current transmission time slot is not greater than the number of antennas of the access point with multiple antennas; and
setting the start antenna index of a station to be set according to the relation between the station to be set and other stations in the updated transmission time slot of the station to be set.

8. The wireless transmission method of claim 7, wherein the sorted order of the plurality of stations is determined by the number of antennas of each of the plurality of stations, and the sorted order does not include the stations from which the access point does not receive the requests to transmit signals.

9. The wireless transmission method of claim 8, wherein the station with the greatest number of antennas is listed in the first place of the updated sorted order, and the station with the smallest number of antennas is listed in the last place of the updated sorted order.

10. A wireless transmission method for a spatial division multiple access system, comprising the steps of:
receiving a broadcasted control frame signal, wherein the control frame signal includes transmission time slots and start antenna indexes of a plurality of stations in a spatial division multiple access system;
transmitting a request to transmit signals to an access point with multiple antennas according to the transmission time slots and start antenna indexes of the plurality of stations and waiting for a clear to transmit signal from the access point with multiple antennas;
receiving the clear to transmit signal from the access point with multiple antennas; and
transmitting data signals to the access point with multiple antennas according to the clear to transmit signal;
wherein the request to transmit signal, which is transmitted based on the transmission time slots and start antenna indexes of the plurality of stations, conforms to a multi-input multi-output transmission standard of the access point.

11. The wireless transmission method of claim 10, wherein the setup of the transmission time slots and start antenna indexes of the plurality of stations comprises the steps of:
determining transmission time slots of the plurality of stations according to a sorted order of the plurality of stations;
setting the current transmission time slot as the next time slot of the current transmission time slot if the sum of the number of antennas of a station to be set and the number of antennas of other stations in the current transmission time slot is greater than the number of antennas of the access point with multiple antennas;
setting the transmission time slot of a station to be set as the current transmission time slot if the sum of the number of antennas of the station to be set and the number of antennas of other stations in the current transmission time slot is not greater than the number of antennas of the access point with multiple antennas; and
setting the start antenna index of a station to be set according to the relation between the station to be set and other stations in the transmission time slot of the station to be set.

12. The wireless transmission method of claim 11, wherein the sorted order of the plurality of stations is determined by the number of antennas of each of the plurality of stations.

13. The wireless transmission method of claim 12, wherein the station with the greatest number of antennas is listed in the first place of the sorted order, and the station with the smallest number of antennas is listed in the last place of the sorted order.

14. The wireless transmission method of claim 10, wherein the control frame signal is broadcasted by applying a carrier sense multiple access mechanism.

15. The wireless transmission method of claim 10, wherein the clear to transmit signal comprises updated transmission time slots and start antenna indexes of the plurality of stations.

16. The wireless transmission method of claim 15, wherein the setup of the updated transmission time slots and start antenna indexes of the plurality of stations comprises the steps of:
determining updated transmission time slots of the plurality of stations according to an updated sorted order of the plurality of stations;
setting the current transmission time slot as the next time slot of the current transmission time slot if the sum of the number of antennas of a station to be set and the number of antennas of other stations in the current transmission time slot is greater than the number of antennas of the access point with multiple antennas;
setting the transmission time slot of a station to be set as the current transmission time slot if the sum of the number of antennas of the station to be set and the number of antennas of other stations in the current transmission time slot is not greater than the number of antennas of the access point with multiple antennas; and
setting the start antenna index of a station to be set according to the relation between the station to be set and other stations in the updated transmission time slot of the station to be set.

17. The wireless transmission method of claim 16, wherein the sorted order of the plurality of stations is determined by the number of antennas of each of the plurality of stations, and the sorted order does not include the stations from which the access point does not receive the requests to transmit signals.

18. The wireless transmission method of claim 17, wherein the station with the greatest number of antennas is listed in the first place of the updated sorted order, and the station with the smallest number of antennas is listed in the last place of the updated sorted order.

19. The wireless transmission method of claim 15, wherein the transmitted data signals, which are transmitted based on the updated transmission time slots and start antenna indexes of the plurality of stations, to conform to a multi-input multi-output transmission standard of the access point.
